(19) United States
(12) Patent Application Publication
(10) Pub. No.: US 2024/0263828 A1
(43) Pub. Date: Aug. 8, 2024

(54) A CONNECTOR PIECE AND A METHOD OF MANUFACTURING A CONNECTOR PIECE FOR VENTILATION DUCTS RESISTING HIGH TEMPERATURES

(71) Applicant: Climate Recovery Ind AB, KALMAR (SE)

(72) Inventors: Peter WALLIN, KALMAR (SE); Andreas WALLIN, KALMAR (SE); Göran BERNHARDSSON, BÅSTAD (SE)

(21) Appl. No.: 18/695,926

(22) PCT Filed: Oct. 7, 2022
(86) PCT No.: PCT/SE2022/050907

§ 371 Date: Mar. 27, 2024

(30) Foreign Application Priority Data
Oct. 8, 2021 (SE) 2151234-8

(51) Int. Cl. F24F 13/02

(52) U.S. Cl. CPC F24F 13/0209; F24F 13/0245; F24F 13/0281

(57) ABSTRACT

Ventilation duct connector piece for connection with ventilation ducts or connector pieces, formed by two complementing parts (10a, 10) providing a flow space (4) and having at least two open ends (12), each part (10a, 10b) comprising a fibre layer (2) and an inner layer (3), wherein
the fibre layer (2) comprises mineral fibres and a binder, compressed into a desired shape, the fibres having a melting point over 800 degrees Celsius,
the inner layer (3) is a stainless-steel foil having a thickness of 0.01-0.3 mm, facing the flow space (4).

A method of manufacturing the connector piece wherein the steel foil is pressed into two complementing parts, joined along its edges; a binder solution is sprayed on a fibre layer and compressed into two complementing parts under heated conditions, so water evaporates, whereafter two fibre parts are positioned on the two steel foil parts.

The present invention concerns a connector piece for ventilation ducts capable of resisting high temperatures for a long period of time.

There are classifications for the possibility of withstanding high temperatures for ducts. The ducts transfers flue gas and must withstand temperatures between 900 and 1000 degrees Celsius for at least half an hour or at least an hour to fulfil a European classification EN1366 according to EI30/60. This will give people time to evacuate a burning building. According to this classification the cross section must be intact, and the outside temperature of the duct must not exceed 140 degrees Celsius in average and not over 180 degrees Celsius in one point.

At the moment steel ducts are arranged in buildings, which thereafter are provided with mineral wool to insulate the ducts. The mineral wool is usually attached by means of chicken wire around the ducts and mineral wool.

The aim of the present invention is to provide an easily handled, lightweight ventilation duct connector piece fulfilling at least the classification EN1366 according to EI30/60.

### SUMMARY OF THE INVENTION

According to a first aspect of the invention the aim can be met by means of a ventilation duct connector piece for connection with at least one elongated ventilation duct or a further connector piece. The connector piece is formed by two complementing parts providing a flow space in between and having at least two open ends for connection. Each part comprises a fibre layer and an inner layer. The fibre layer comprises mineral fibres and a binder and being compressed into a desired duct connector piece shape. The mineral fibres having a melting point over 800 degrees Celsius. The inner layer is a stainless-steel foil having a thickness of 0.01-0.3 mm, facing the flow space.

By means of the present invention a low weight and fire resisting ventilation duct connector piece is provided. This means that the ventilation duct connector piece is ready for transport to a building site and to be arranged in the building. There will not be necessary for other transports of insulating material and chicken wire. Neither the extra workload to attach the insulating material at the connector piece when they are arranged in the building is needed. Thus, it is faster and easier to arrange the connector pieces according to the invention. Additionally, the ventilation duct connector piece of the invention is sound dampening, which means that any vibrations in the duct will not transfer to adjacent building structures due to its semisoft formation. Due to its semisoft formation, it is also a bit flexible. The connector piece also comprises a minimum of heat-conducting material and a minimum of energy. The stainless-steel foil helps the duct to withstand high temperatures and protects from corroding.

According to some embodiments an outer layer is provided on an outer side of the fibre layer. The outer layer comprises an aluminium foil and a polyethene layer for attachment to the fibre layer. This make the ducts easier and safer to handle since the fibres are encapsuled inside the outer layer.

According to some embodiments the ventilation duct connector piece lacks binding material between the fibre layer and the inner layer. This keeps the energy level low in the ventilation duct, which keeps the temperature down in the duct.

According to some embodiments the inner layer comprises two complementing steel foils having rims along its edges which rims are joined forming the inner layer and thus the flow space.

According to some embodiments the mineral fibre length is at least 10 mm, preferably at least 20 mm or at least 30 mm. Due to the long fibres the compressed fibre layer will stay intact also after the binder is burnt out.

According to some embodiments the fibre layer is self-supported.

According to some embodiments the amount of binder in the fibre layer is 1-5% by weight before the compression.

According to some embodiments the binder is phenolic based and water soluble.

According to some embodiments the outer layer is black. Thus, heat will dissipate easily.

According to some embodiments the amount of polyethene is between 10-50 g/m², preferably 15-30 g/m².

According to some embodiments a sleeve coupling is provided at at least one of the open ends. Thus, it is ready for easy attachment with an elongated ventilation duct or a further connector piece.

According to a second aspect of the invention a method of manufacturing a ventilation duct connector piece of two complementing parts having at least two open ends for connection with an elongated ventilation duct or a further connector piece is provided. Each connector piece has a mineral fibre layer and an inner layer of stainless-steel foil having a thickness of 0.01-0.3 mm. The stainless-steel foil is pressed into two complementing parts of a desired connector part shape. The two complementing parts are joined along its edges forming a joint so that the inner layer of each part faces the other, whereby a flow space is provided. A binder solution is sprayed on a mineral fibre layer, which layer is compressed into two complementing parts of the desired connector part shape under heated conditions so that water in the binder solution evaporates. The two complementing compressed fibre layer parts are positioned towards each other on the outside of the joined two complementing stainless-steel foil parts.

According to some embodiments the two complementing stainless steel foils are joined by means welding, riveting or folding.

According to some embodiments a fire-resistant acrylic is provided as a sealing in the joint between the two complementing stainless-steel foils.

According to some embodiments an outer layer, comprising an aluminium foil and a polyethene foil, is provided on the outside of the fibre layer and heated so that the polyethene foil melts and thus bonds the outer layer to the fibre layer.

According to some embodiments the joint between the two complementing mineral fibre layers having outer layers are covered by aluminium strips on the outside to seal the outside of the ventilation duct connector piece.

According to some embodiments the two mineral fibre layer parts are fastened by means of an encircling steel strap or steel wire outside of the mineral fibre layer or outside the outer layer, if present.

According to some embodiments a sleeve coupling is provided at at least one of the open ends.

### SHORT DESCRIPTION OF THE DRAWINGS

The present invention will be described in more detail under referral to the drawings, in which

FIG. 1 shows a ventilation duct connector piece according to an embodiment of the invention in a perspective view.

FIG. 2 shows a cross-sectional view of another embodiment.

FIG. 3 shows a close-up section view showing ingoing layers of an embodiment in more detail.

FIG. 4 shows one part of an inner layer of an embodiment during manufacture in a perspective view.

FIG. 5 shows a cross-sectional view of two parts of inner layer joined to form a flow space.

FIG. 6 shows a cross-sectional view of two complementing parts of an embodiment being put together.

FIG. 7 shows an example of sleeve coupling arranged at one open end of a ventilation duct connector piece in a cross-sectional detail view.

### DETAILED DESCRIPTION OF EMBODIMENTS OF THE INVENTION

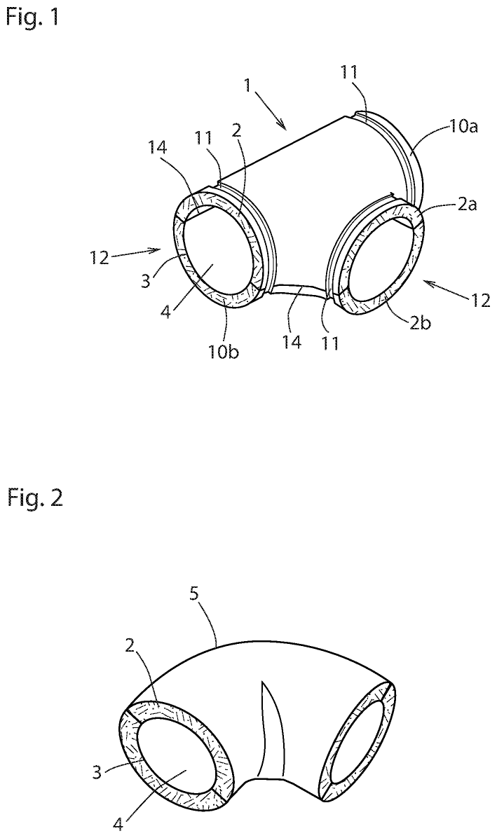

In FIG. 1 an embodiment of a ventilation duct connector piece 1 comprising a fibre layer 2 and an inner layer 3 surrounding an elongated flow space 4 is shown in perspective. The ventilation duct connector piece 1 has at least two open ends 12 for connection with elongated ventilation ducts or further connector pieces 1. The ventilation duct connector piece is built up by two complementing parts 10a, 10b having a joint 14 between the two parts 10a, 10b and providing a flow space 4. In some embodiments the complementing parts are mirror-symmetrical. The two complementing parts 10a, 10b may for example be united by means of at least one strap 11, for example provided close to the open ends 12. The cross-sectional shape of the ventilation duct connector piece 1 may have any suitable shape corresponding to other parts for a ventilation system, such as a corresponding shape of an elongated duct. In the shown embodiment the ventilation duct connector piece 1 has three open ends 12 having a circular shape, thus providing a T-connector piece as the overall shape. Obviously, the ventilation duct connector piece may have all sorts of overall shapes, such as bends of different degrees.

The fibre layer 2 is made of mineral fibres being compressed with a binder. The mineral fibres should have a melting point over 800 degrees Celsius. The fibres may have a length of at least 10 mm, preferably at least 20 mm or at least 30 mm. In some embodiments the fibre fulfils the classification RAL/40. As is evident form the figures, especially FIGS. 1, 2 and 6, and the description below, the fibre layer of each complementing part is without any splices.

The mineral fibres are sprayed with a binder solution, which preferably is based on a water-soluble phenolic resin. Thereafter the mineral fibres are compressed and heated in a form to reach its final shape of two complementing parts 2a, 2b. During the compression and heating the water in the binder solution evaporates and the phenolic resin cures at a temperature around 200 degrees Celsius. The amount of binder solution before the forming procedure, i.e., the compression and heating, is between 1-5% by weight. The amount of binder is kept to a minimum in order to avoid adding too much energy into the ventilation duct connector piece, which energy would increase the temperature in case of fire. It is also conceivable to use other binders than phenolic based.

After the compression and heating step of the fibre layer, the fibre layer is stiff enough to be self-supported so the ventilation duct connector piece is self-supported.

The inner layer is a steel foil having a thickness of 0.01-0.3 mm, preferably 0.01-0.2 mm and most preferred 0.03-0.1. In one embodiment the steel foil is a stainless steel foil. As an example, AISI 304 may be a suitable steel.

In FIG. 2 another embodiment is shown in a perspective view. According to this embodiment the ventilation duct connector piece 1 comprises a fibre layer 2, an inner layer 3 and an outer layer 5. The outer layer 5 comprises at least an aluminium foil and a layer of polyethene. The amount of aluminium may be 15-25 gram/m². The amount of polyethene may be 10-50 g/m², preferably 15-30 g/m².

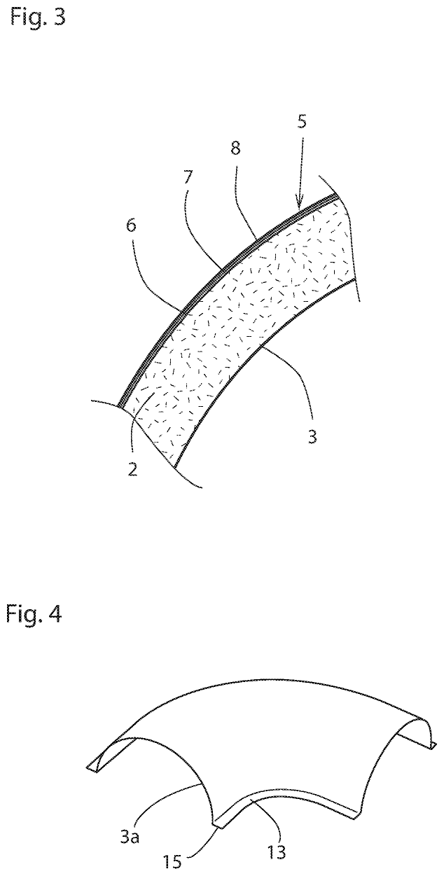

In FIG. 3 a section of an embodiment of a ventilation duct connector piece 1 is shown. In this embodiment the connector piece is built up by an inner layer 3, a fibre layer 2 and an outer layer 5. The outer layer 5 comprises a layer of polyethene 6 closest to the fibre layer 2. The polyethene layer 6 functions as a binder and will stick to the fibre layer 2 by a heating step during production where the polyethene melts and thus bonds the outer layer 5 to the fibre layer 2. Outermost is a layer of aluminium 8 provided. In between a mesh, net or spread glass fibres 7 is provided. The layer of glass fibres 7 increases the strength of the outer layer 5. Preferably, the aluminium 8 is black on its outside, which promote heat dissipation. Generally, the outer layer 5 is arranged to enhance the look of the ventilation duct and to encapsule the fibre, which increases health standards when working with the ducts and the possibility to keep clean.

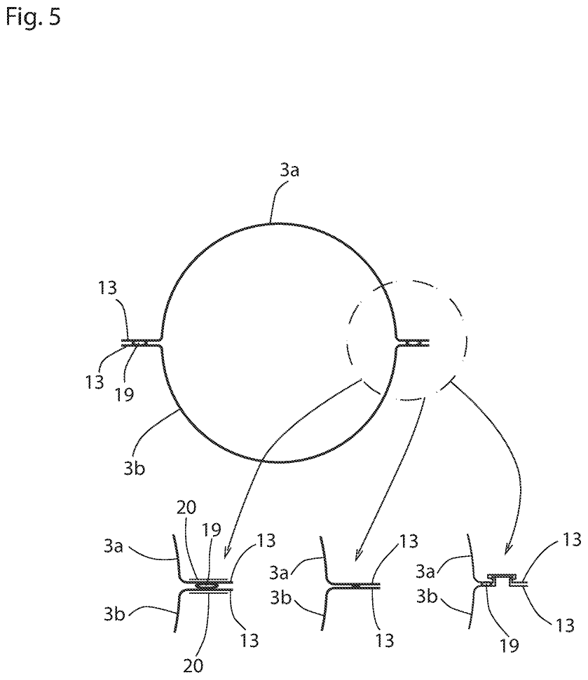

Under referral to FIGS. 4 and 5 the production of the inner layer can be described. Two complementing parts 3a, 3b are manufactured by pressing sheets of steel foil in a suitable form, and then put against each other. The parts 3a, 3b are preferably provided with rims 13 along side edges except at the open ends 12. In FIG. 5 two parts are joined to each other. The rims 13 of the steel foils parts 3a, 3b are joined by means of welding, such as seam or spot welding, or riveting. It is also possible to unite by means of folding. If needed it is possible to provide sealing material 19 in the joint between the two steel foils parts 3a, 3b. This could for example be expandable fire acrylic sealing material. The examples in FIG. 5 shows, from left to right, a joint having supporting shims 20 on each side of the joint, which is spot welded or riveted; a seam welded joint, which does not require sealing material 19; and a folded joint.

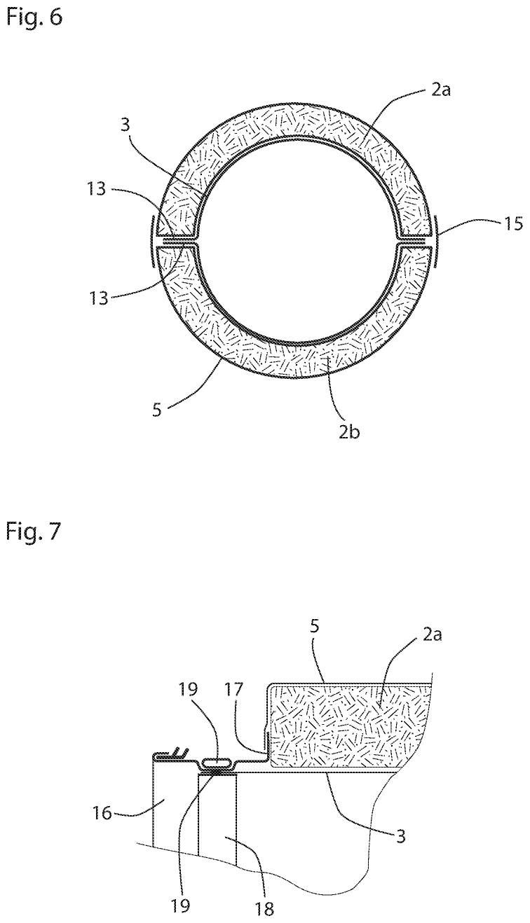

After uniting the two complementing steel foils parts 3a, 3b they are providing a flow space 4. On the outside of the inner layer 3, made up by the two complementing steel foils parts 3a, 3b, two complementing fibre layer parts 2a, 2b are arranged, see FIG. 6. Preferably, the two complementing fibre layer parts 2a, 2b are attached by means of at least one encircling steel strap or steel wire 11 at an open end 12, preferably at all open ends 12, as seen in FIG. 1. In some embodiments an aluminium tape 15 is provided over the joint 14 between the two complementing parts 10a, 10b, see FIG. 6.

If an outer layer 5 is used it is preferably attached on the fibre layer parts 2a, 2b before they are being arranged on the inner layer 3 and thus the strap or wire 11 is encircling both the fibre layer 2 and the outer layer 5. As a matter of fact, it is possible to arrange the outer layer 5 in the press form before the fibre material so that the fibre layer part 2a, 2b having an outer layer 5 will be jointly manufactured. The joint 14 between the two complementing parts 10a, 10b may be covered by a strip 15 of aluminium or of the outer layer material to seal the outside of the ventilation duct connector piece 1. However, it is possible to attach the outer layer 5 after the two fibre layer parts 2a, 2b are arranged on the inner layer 3.

The rim 13 may not be wider than the thickness of the fibre layer 2 so that any risk of cutting by the rims 13 is avoided. According to one embodiment the outer layer 5 also covers at least a part of the thickness of the fibre layer 2 along the joint 14 of each part 2a, 2b.

Preferably, there is no binding material between the fibre layer 2 and the inner layer 3. In this way the total energy content of the elongated ventilation duct can be kept low. However, an inorganic adhesive is conceivable in order to stick the inner layer 3 to the fibre layer 2.

According to some embodiments a sleeve coupling 16 is arranged at at least one of the open ends 12. In FIG. 7 one example of how this could be carried out is shown. Of course, many other ways to attach a sleeve coupling 16 may be conceived. In the shown example the inner layer 3 protrudes further out than the fibre layer 2. On the outside of the protruding inner layer 3 a sleeve coupling 16 having an outer rim 17 is positioned so that the outer rim 17 is adjacent an open end surface of the fibre layer 2. Preferably the outer rim 17 has a width which is less than the thickness of the fibre layer 2.

A steel band 18 is arranged on an inner side of the sleeve coupling 16 and the protruding inner layer 3 and clamps the protruding inner layer 3 between the steel band 18 and the sleeve coupling 16. Preferably, the steel band 18 is welded or riveted to the sleeve coupling 16. Expandable fire acrylic sealing material 19 may be arranged between the sleeve coupling 16 and the protruding inner layer 3 as well as between the inner layer 3 and the steel band 18. If an outer layer 5 is used it is preferred that it also covers the open end surface of the fibre layer 2 and also a portion of the outer rim 17 of the sleeve coupling 16. An elongated ventilation duct or a further ventilation duct connector piece 1 may be arranged at the protruding portion.

1. A ventilation duct connector piece (1) for connection with at least one elongated ventilation duct or a further connector piece, the connector piece being formed by two complementing parts (10a, 10) providing a flow space (4) in between and having at least two open ends (12) for connection, each part (10a, 10b) comprising a fibre layer (2) and an inner layer (3), wherein
the fibre layer (2) comprises mineral fibres and a binder, compressed into a desired duct connector piece shape, the mineral fibres having a melting point over 800 degrees Celsius, and
the inner layer (3) is a stainless-steel foil having a thickness of 0.01-0.3 mm, facing the flow space (4), wherein the inner layer (3) comprises two complementing stainless-steel foils having rims (13) along its edges which rims are joined forming the inner layer (3) and thus the flow space (4).

2. The ventilation duct connector piece according to claim 1, wherein an outer layer (5) is provided on an outer side of the fibre layer (2), the outer layer comprises an aluminium foil (8) and a polyethene layer (6) for attachment to the fibre layer.

3. The ventilation duct connector piece according to claim 1, wherein the ventilation duct connector piece (1) lacks binding material between the fibre layer (2) and the inner layer (3).

4. (canceled)

5. The ventilation duct connector piece according to claim 1, wherein the mineral fibre length is at least 10 mm, preferably at least 20 mm.

6. The ventilation duct connector piece according to claim 1, wherein the fibre layer is self-supported.

7. The ventilation duct connector piece according to claim 1, wherein the binder is phenolic based and water soluble.

8. The ventilation duct connector piece according to claim 1, wherein the outer layer is black.

9. The ventilation duct connector piece according to claim 1, wherein the amount of polyethene is between 10-50 g/m², preferably 15-30 g/m².

10. The ventilation duct connector piece according to claim 1, wherein a sleeve coupling (16) is provided at at least one of the open ends (12).

11. A method of manufacturing a ventilation duct connector piece (1) of two complementing parts (10a, 10b) having at least two open ends (12) for connection with an elongated ventilation duct or a further connector piece, each having a mineral fibre layer (2) and an inner layer (3) of stainless-steel foil having a thickness of 0.01-0.3 mm, wherein the stainless-steel foil is pressed into two complementing stainless-steel foil parts (3a, 3b) of a desired connector part shape, the two complementing stainless-steel foil parts (3a, 3b) are joined along its edges forming a joint so that the inner layer (3) of each part faces the other, whereby a flow space (4) is provided; a binder solution is sprayed on the mineral fibre layer (2), the mineral fibre layer (2) is compressed into two complementing parts (2a, 2b) of the desired connector part shape under heated conditions so that water in the binder solution evaporates, whereafter two complementing compressed mineral fibre layer parts (2a, 2b) are positioned towards each other on an outside of the joined two complementing stainless-steel foil parts (3a, 3b).

12. The method according to claim 11, wherein the two complementing stainless-steel foils are joined by means welding, riveting or folding.

13. The method according to claim 11, wherein a fire-resistant acrylic (19) is provided as a sealing in the joint between the two complementing stainless-steel foils (3a, 3b).

14. The method according to claim 11, wherein an outer layer (5), comprising an aluminium foil (8) and a polyethene foil (6), is provided on an outside of the fibre layer (2) and heated so that the polyethene foil (6) melts and thus bonds the outer layer (5) to the fibre layer (2).

15. The method according to claim 14, wherein the joint between the two complementing fibre layers (2a, 2b) having outer layers (5) are covered by aluminium strips (15) on the outside to seal the outside of the ventilation duct connector piece.

16. The method according to claim 11, wherein the two fibre layer parts (2a, 2b) are fastened by means of an encircling steel strap or steel wire (11) outside of the mineral fibre layer (2) or outside the outer layer (5), if present.

17. The method according to claim 11, wherein a sleeve coupling (16) is provided at at least one of the open ends (12).
